(19) United States
(12) Patent Application Publication
(10) Pub. No.: US 2006/0103985 A1
(43) Pub. Date: May 18, 2006

(54) Head drum assembly and magnetic recording/reproducing apparatus having the same

(75) Inventors: Jae-Hoon Sim, Suwon-si (KR); Bong-Joo Kim, Suwon-si (KR); Hyeong-Seok Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/268,573

(22) Filed: Nov. 8, 2005

(30) Foreign Application Priority Data
Nov. 12, 2004 (KR) 2004-92215

(51) Int. Cl. G11B 5/52

(52) U.S. Cl. 360/271.1

(57) ABSTRACT

A head drum assembly is disclosed which can prevent a magnetic tape from departing from a tape traveling system. The head drum assembly comprises a head drum which records information to a magnetic tape traveling along a defined track or reproduces information recorded on the magnetic tape. A departure preventing member is provided on a top surface of the head drum so as to prevent the magnetic tape from departing from the head drum.

### CROSS-REFERENCE TO RELATED APPLICATIONS

This application claims the benefit under 35 U.S.C. § 119 (a) of Korean Patent Application No. 10-2004-0092215, filed on Nov. 12, 2004, the entire disclosure of which is hereby incorporated by reference.

### BACKGROUND OF THE INVENTION

1. Field of the Invention

The present invention relates to a magnetic recording/reproducing apparatus. More particularly, the present invention relates to a head drum assembly having a tape departure preventing member and a magnetic recording/reproducing apparatus having the same.

2. Description of the Related Art

In general, a magnetic recording/reproducing apparatus is an apparatus which records information to a recording medium such as a magnetic tape or reproduces information recorded on such a recording medium. The magnetic recording/reproducing apparatus includes, for example, a video cassette tape recorder (VCR) and a camcorder.

Generally, magnetic recording/reproducing apparatuses comprise a deck, a pair of reel assemblies mounted on the deck to rotate the reels of a tape cassette arranged on the reel assemblies, a guide assembly mounted on the deck in such a way that the guide assembly can draw out the magnetic tape from the tape cassette and guide the traveling of the drawn magnetic tape, and a head drum assembly rotatably mounted on the deck in such a way that the head drum assembly can record information to/reproduce information from the magnetic tape guided by the guide assembly.

The guide assembly comprises a tension pole unit which controls the tension of the magnetic tape when the tape is in the drawing out and playing modes. Moreover, the guide assembly has plural guide poles which guide the magnetic tape to the head drum assembly.

The head drum assembly comprises a shaft, a stationary drum affixed to the shaft, and a rotary drum mounted to face the stationary drum. The magnetic drum is supported by the rotary drum and a drum cover is positioned on top of the rotary drum.

The magnetic recording/reproducing apparatus, configured as described above, operates as follows. At first, if a user seats a tape cassette on the reel assemblies, the tension pole unit and the guide poles draw out the magnetic tape from the tape cassette while moving on the deck. Thus, moving the magnetic tape into close contact with the head drum assembly. When such a loading operation is complete, and the user selects the play mode, the reel assemblies are rotated by the capstan motor and the magnetic tape travels. The magnetic head supported by the rotary drum scans information from the magnetic tape while the rotary drum rotates.

Recently, with the arrival of portable magnetic recording/reproducing apparatuses such as a compact camcorder, the apparatus is frequently impacted as a user carries the device. Furthermore, the user may carry or grasp the magnetic recording/reproducing apparatus in various positions.

In addition, while the magnetic tape is drawn out, at the time of loading or the magnetic recording/reproducing apparatus is changed from the play mode to the stop mode, the magnetic tape sometimes unwinds from the tape cassette more than necessary. Due to this action, it is difficult for the magnetic tape to closely contact the guide assembly. Therefore, a gap is produced. Consequently, if the magnetic recording/reproducing apparatus is impacted or placed in an inverted position, the magnetic tape may depart, not only from the head drum assembly, but also from the guide assembly.

Meanwhile, the severity of the aforementioned problems increases when a brake unit from the reel assemblies is removed.

Accordingly, there is a need for improved magnetic recording/reproducing apparatus having a head drum assembly which provides stability by preventing departure from a tape traveling system.

### SUMMARY OF THE INVENTION

An aspect of the present invention is to solve at least the above problems and/or disadvantages and to provide at least the advantages described below. Accordingly, an aspect of the present invention is to provide an object of the present invention is to provide a head drum assembly configured to provide stability to a traveling magnetic tape and a magnetic recording/reproducing apparatus having the same.

Another object of the present invention is to provide a head drum assembly that can prevent a magnetic tape from departing from a tape traveling system and a magnetic recording/reproducing apparatus having the same.

In order to achieve the above-mentioned objects, according to an aspect of the present invention, there is provided a head drum assembly comprising a head drum which records information to a magnetic tape traveling along a track or reproduces information recorded on the magnetic tape. A departure preventing member is provided on a top surface of the head drum so as to prevent the magnetic tape from departing from the head drum.

According to another aspect of the present invention, there is also provided a magnetic recording/reproducing apparatus comprising a tape traveling system configured to rotate a magnetic tape along a track. A head drum is provided which records information to the magnetic tape or reproduces information recorded on the magnetic tape. A departure preventing member is provided on a top surface of the head drum so as to prevent the magnetic tape from departing from the head drum.

According to an embodiment of the present invention, the head drum comprises a shaft, a stationary drum secured to the shaft, a rotary drum rotatably fitted on the shaft to face the stationary drum, and a drum cover placed on a top surface of the rotary drum and secured to the shaft, and the departure preventing member is integrally formed with the drum cover to extend from a magnetic tape input point (I.P.) to a magnet tape output point (O.P.) along the circumference of the drum cover.

According to another embodiment of the present invention, the departure preventing member extends from a magnetic tape input point (I.P.) to a half point (H.P.) between the magnetic tape input point (I.P.) and a magnetic tape output point (O.P.) along the circumference of the drum cover and upwardly inclines at a predetermined angle θ from the top surface of the drum cover. In addition, it is preferable to determine the angle θ in such a manner that the departure preventing member is parallel to the magnetic tape at the magnetic tape input point (I.P.).

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a perspective view schematically showing a magnetic recording/reproducing apparatus according to an embodiment of the present invention;

FIG. 2 is an exploded perspective showing the head drum assembly of FIG. 1;

FIG. 3 is a front view showing the head drum of FIGS. 1-2 in partial cross-section;

FIG. 4 is a top plan view of a head drum assembly according to another embodiment of the present invention; and

FIG. 5 is a front view showing the head drum assembly of FIG. 4 in partial cross section.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

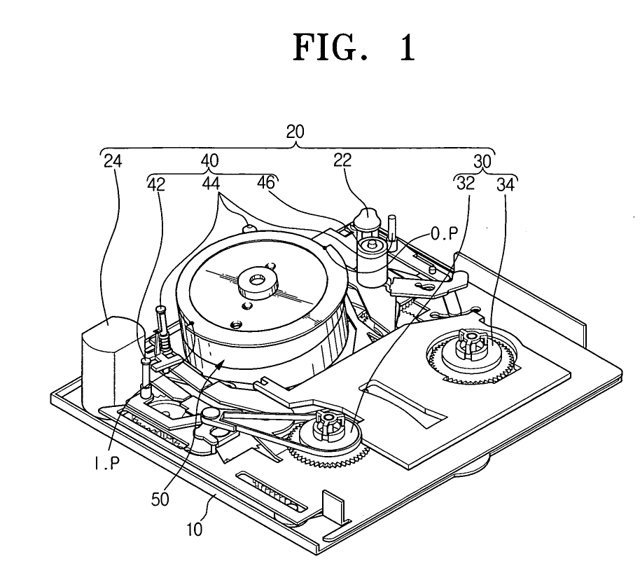

Referring to FIG. 1, a magnetic recording/reproducing apparatus according to an embodiment of the present invention comprises a deck 10, a tape traveling system 20, and a head drum assembly 50.

The deck is a chassis, on which the tape traveling system 20 and the head drum assembly 50 are mounted. Although the deck may comprise a main deck and a subordinate deck mounted to slide on the main deck, it is possible to construct the main deck with a single chassis, for example, where the subordinate deck is removed.

The tape traveling system 20 draws out magnetic tape from a cassette tape and guides tape toward the head drum assembly 50. The tape traveling system 20 comprises a capstan motor 22, a loading motor 24, reel assemblies 30 and a guide assembly 40.

The capstan motor 22 supplies a driving force to the reel assemblies 30 so that the reel assemblies 30 can rotate the reels of the tape cassette arranged on the reel assemblies 30.

The loading motor 24 supplies a driving force to the guide assembly 40 so that the guide assembles 40 can draw out the magnetic tape from the tape cassette at the time of loading the tape cassette.

The reel assemblies 30 include a supply reel assembly 32 and a take-up reel assembly 34 to wind the supplied magnetic tape.

The guide assembly 40 includes a tension pole unit 42 for drawing out the magnetic tape from the tape cassette at the time of loading the tape cassette and controlling the tension of the magnetic tape as the magnetic tape travels. The guide assembly 40 also includes plural pole members 44 and roller members 46 which guide the travel of the magnetic tape.

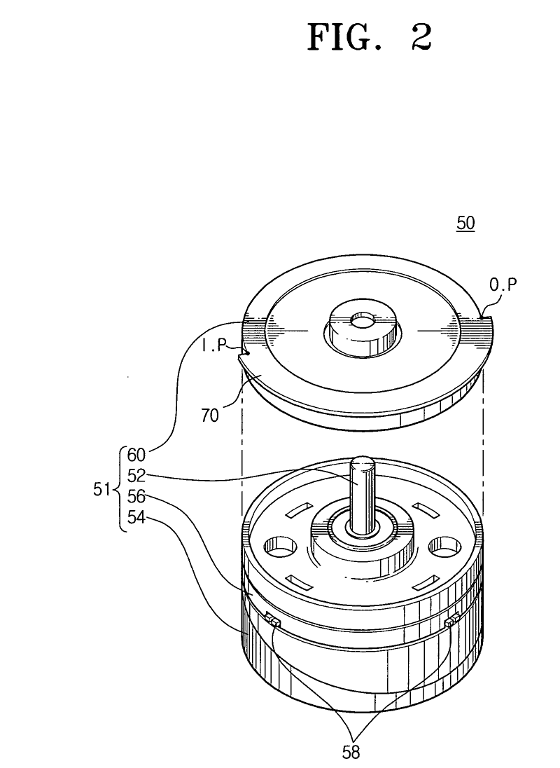

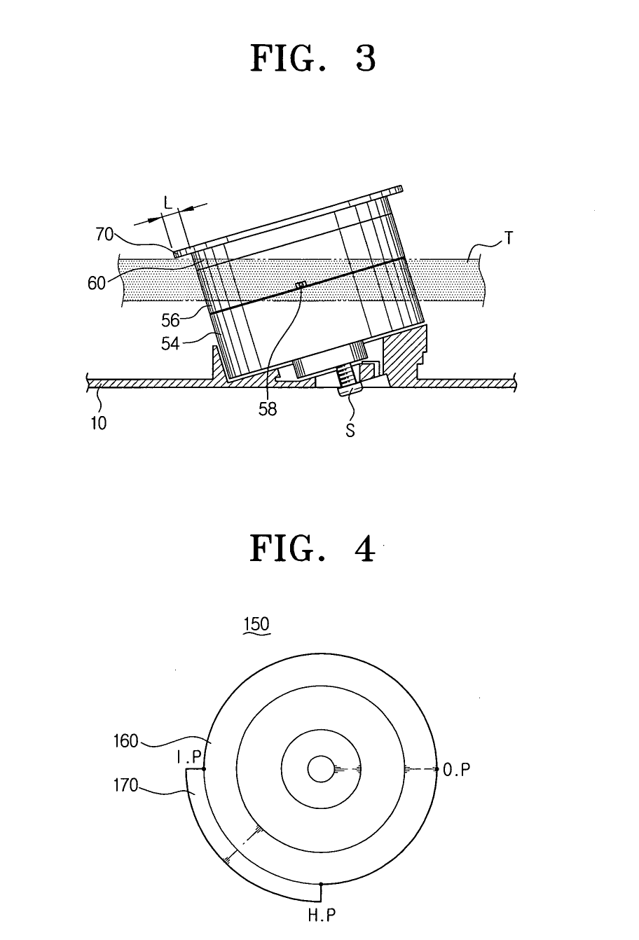

The head drum assembly 50 records information to the magnetic tape to guide the guide assembly or reproduce information recorded on the magnetic tape and is mounted on the deck 10. Preferably, the head drum assembly 50 is angled at a predetermined angle. Now, the head drum assembly 50 is described in detail with reference to FIGS. 2 and 3.

Referring to FIGS. 2 and 3, the head drum assembly 50 comprises a head drum 51 which records information to a magnetic tape T traveling along a defined track or reproduces information recorded information on the magnetic tape T while the magnetic tape T is guided by the guide assembly 40 (see FIG. 1). A departure preventing member 70 is provided on the top of the head drum 51 so as to prevent the magnetic tape T from departing from the head drum 51.

The head drum 51 comprises a shaft 52, a stationary drum 54 secured to the shaft 52, a rotary drum 56 rotatably fitted on the shaft 52 to face the stationary drum 54, and a drum cover 60 placed on top of the rotary drum 56 and secured to the shaft 52.

The stationary drum 54 is fixed on the deck 10 with a fastener such as a screw S, and the shaft 52 is inserted into the stationary drum 54. In addition, the surface of the stationary drum 54 faces the rotary drum 56 and is provided with a motor stator (not shown).

The rotary drum 56 is placed on a top surface of the stationary drum 54 and rotatably arranged on the shaft 52. In general, a bearing (not shown) is interposed between the rotary drum 56 and the shaft 52 so as to allow the rotation of the rotary drum 56 about the shaft 52. In addition, a motor rotor (not shown) is installed to face the motor stator in order to generate a rotational driving force. Furthermore, a magnetic head 58 is mounted on the rotary drum 56 and may project from the circumference of the rotary drum 56 so that the magnetic head 58 can record information to the magnetic tape or reproduce the recorded information from the magnetic tape. A rotary transformer (not shown) is installed on the top surface of the rotary drum 56, wherein the rotary transformer is connected to the magnetic head 58 to communicate signals with the magnetic head 58.

The drum cover 60 may be fixedly press-fitted onto shaft 52 and a stationary transformer (not shown) is mounted on the surface of the drum cover 60 facing the rotary drum 56, wherein the stationary transformer is paired with the rotary transformer, so that the stationary transformer can communicate signals with the rotational magnetic head 58.

The departure preventing member 70 is integrally formed with the drum cover 60 by a forming method such as casting. The departure preventing member 70 is shaped radially and projects from the drum cover 60. However, other suitable arrangements and constructions may be used, such as assembling a departure preventing member 70 to the drum cover 60 using an adhesive or a screw. The departure preventing member 70 is formed along the circumference of the drum cover 60 and extends from an input point (I.P.), where the magnetic tape T is inputted into and in contact with the head drum assembly 50 to an output point (O.P.), where the magnetic tape gets out of the head drum assembly 50. Accordingly, the departure preventing member 70 is formed to cover the contact surface in which the magnetic tape comes into contact with the head drum assembly 50. With this arrangement, the departure preventing member 70 can prevent the magnetic tape T from upwardly departing from the head drum assembly 50 even if the magnetic recording/reproducing apparatus is impacted or inverted when the magnetic tape T is spaced from the guide assembly 40 (see FIG. 1) and the head drum assembly 50. However, the projected length L of the departure preventing member 70 from the drum cover 60 may be determined in such a way that the magnetic tape T cannot come into contact with the departure preventing member 70 over the projected length L. Accordingly, it is necessary to properly tune the projected length L of the departure preventing member 70 in consideration of the angle of the head drum assembly 50 with respect to the deck 10.

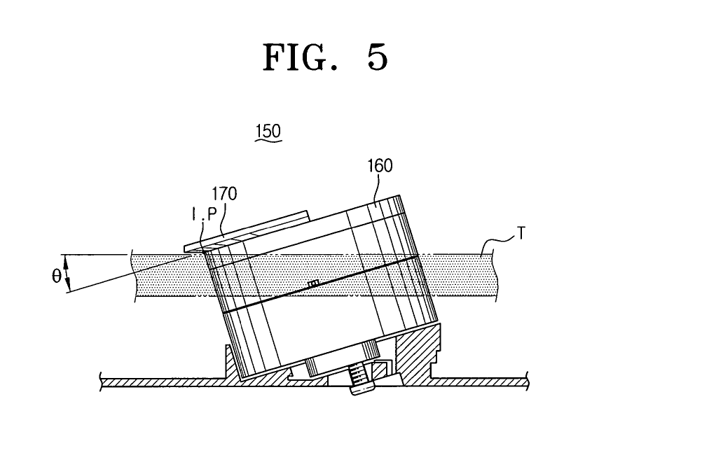

FIGS. 4 and 5 are top plan view and front views in partial cross-section of a head drum assembly according to another exemplary embodiment of the present invention, respectively.

Referring to FIG. 4, the head drum assembly 150 comprises a departure preventing member 170, which is formed along the circumference of the drum cover 160 to extend only from the input point (I.P.) to a mid point (H.P.) between the input point (I.P.) and the output point (O.P.) In contrast with the above-mentioned embodiment, the head drum assembly 150 is angularly installed on the deck 10 so that it tilts toward the input point (I.P.). The departure preventing member 170 is closest to the magnetic tape T at the input point (I.P.). Accordingly, by forming the departure preventing member 170 in this manner, it is possible to reduce material costs and to prevent the departure of the magnetic tape T more efficiently.

Referring to FIG. 5, the departure preventing member 170 upwardly inclines from the top surface of the drum cover 160 at a predetermined angle θ. In the above-mentioned embodiment, because the projected length L (see FIG. 3) of the departure preventing member 70 (see FIG. 3) is limited to a predetermined amount to avoid the contact with the magnetic tape T, the projected length L may not be optimum in some cases. For example, if a gap between the magnetic tape T and the head drum assembly 150 is relatively large, that is, where the magnetic tape T is loose, it is necessary to increase the projected length L; however, the extent of the increase may be limited in order to avoid the contact with the magnetic tape T. Therefore, according to the present embodiment, by making the departure preventing member 170 incline upwardly from the drum cover 160 at a predetermined angle θ, it is possible to increase the projected length L without any of the limitations described above. The predetermined angle θ is determined in such a way that the magnetic tape T is parallel to the departure preventing member 170 at the input point (I.P.), where the magnetic tape is inputted into the head drum assembly 150.

As described above, according to the exemplary embodiments of the present invention, it is possible to prevent a magnetic tape from departing from a head drum assembly by providing a departure preventing member.

In addition, because the magnetic tape is prevented from departing from the head drum assembly even if the apparatus is impacted, the reliability of the product can be enhanced.

Furthermore, because the departure of the magnetic tape from a tape traveling system can be prevented, even if a user inverts the magnetic recording/reproducing, performance of the device is not diminished.

Moreover, since the departure preventing member is integrally formed with a drum cover, it is not necessary to add a separate component or process. Therefore, assembly of the head drum assembly is relatively simple.

While the invention has been shown and described with reference to certain embodiments thereof, it will be understood by those skilled in the art that various changes in form and details may be made therein without departing from the spirit and scope of the invention as defined by the appended claims.

What is claimed is:

1. A head drum assembly comprising:
a head drum which records information to a magnetic tape that travels along a track or reproduces information recorded on the magnetic tape; and
a departure preventing member provided on a top of the head drum so as to prevent the magnetic tape from departing from the head drum.

2. The head drum assembly as claimed in claim 1, wherein the head drum comprises a shaft, a stationary drum secured to the shaft, a rotary drum rotatably fitted on the shaft to face the stationary drum, and a drum cover placed on a top surface of the rotary drum and secured to the shaft, and
wherein the departure preventing member is integrally formed with the drum cover.

3. The head drum assembly as claimed in claim 2, wherein the departure preventing member is formed along a circumference of the drum cover.

4. The head drum assembly as claimed in claim 3, wherein the departure preventing member extends from a magnetic tape input point (I.P.) to a magnet tape output point (O.P.).

5. The head drum assembly as claimed in claim 3, wherein the departure preventing member extends from a magnetic tape input point (I.P.) to a mid point (H.P.) between the magnetic tape input point (I.P.) and a magnetic tape output point (O.P.).

6. The head drum assembly as claimed in claim 5, wherein the departure preventing member upwardly inclines with a predetermined angle θ from the top surface of the drum cover.

7. The head drum assembly as claimed in claim 6, wherein the departure preventing member is parallel to the magnetic tape at the magnetic tape input point (I.P.).

8. A magnetic recording/reproducing apparatus comprising:
a tape traveling system configured to rotates a magnetic tape along a track;
a head drum which records information to the magnetic or reproduces information recorded on the magnetic tape; and
a departure preventing member provided on a top surface of the head drum to prevent the magnetic tape from departing from the head drum.

9. The magnetic recording/reproducing apparatus as claimed in claim 8, wherein the head drum comprises a shaft, a stationary drum secured to the shaft, a rotary drum rotatably fitted on the shaft to face the stationary drum, and a drum cover placed on a top surace of the rotary drum and secured to the shaft, and
wherein the departure preventing member is integrally formed with the drum cover.

10. The magnetic recording/reproducing apparatus as claimed in claim 9, wherein the departure preventing member is formed along a circumference of the drum cover to extend from a magnetic tape input point (I.P.) to a magnet tape output point (O.P.).

11. The magnetic recording/reproducing apparatus as claimed in claim 9, wherein the departure preventing member is formed along a circumference of the drum cover to extend from a magnetic tape input point (I.P.) to a mid point (H.P.) between the magnetic tape input point (I.P.) and a magnetic tape output point (O.P.).

12. The magnetic recording/reproducing apparatus as claimed in claim 11, wherein the departure preventing member upwardly inclines with a predetermined angle θ from the top surface of the drum cover.

13. The magnetic recording/reproducing apparatus as claimed in claim 12, wherein the departure preventing member is parallel to the magnetic tape at the magnetic tape input point (I.P.).

14. A magnetic recording/reproducing apparatus comprising:
a tape traveling system configured to rotates a magnetic tape along a track;
a head drum which records information to the magnetic or reproduces information recorded on the magnetic tape; and
a departure preventing member provided on a top surface of the head drum along a circumference of a drum cover so as to prevent the magnetic tape from departing from the head drum.

15. The magnetic recording/reproducing apparatus as claimed in claim 14, wherein the head drum comprises a shaft, a stationary drum secured to the shaft, a rotary drum rotatably fitted on the shaft to face the stationary drum, and the drum cover is placed on a top surace of the rotary drum and secured to the shaft, and
wherein the departure preventing member is integrally formed with the drum cover.

16. The magnetic recording/reproducing apparatus as claimed in claim 14, wherein the departure preventing member extends from a magnetic tape input point (I.P.) to a magnet tape output point (O.P.).

17. The magnetic recording/reproducing apparatus as claimed in claim 14, wherein the departure preventing member extends from a magnetic tape input point (I.P.) to a mid point (H.P.) between the magnetic tape input point (I.P.) and a magnetic tape output point (O.P.).

18. The magnetic recording/reproducing apparatus as claimed in claim 14, wherein the departure preventing member upwardly inclines with a predetermined angle θ from a top surface of the drum cover.
